(19) United States
(12) Patent Application Publication
(10) Pub. No.: US 2015/0279084 A1
(43) Pub. Date: Oct. 1, 2015

(54) Guided Noise Reduction with Streak Removal for High Speed C-Arm CT

(71) Applicants: Yu Deuerling-Zheng, Forchheim (DE); Michael Manhart, Fürth (DE)

(72) Inventors: Yu Deuerling-Zheng, Forchheim (DE); Michael Manhart, Fürth (DE)

(21) Appl. No.: 14/262,277

(22) Filed: Apr. 25, 2014

Related U.S. Application Data
(60) Provisional application No. 61/973,840, filed on Apr. 1, 2014.

(51) Int. Cl. G06T 15/08; G06T 5/00

(52) U.S. Cl. CPC G06T 15/08; G06T 5/002; G06T 2207/10012; G06T 2207/10081; G06T 2207/30101

(57) ABSTRACT

In order to minimize streak artifacts within reconstructions of perfusion maps generated from moving C-arm acquisitions, a streak reduction method includes threshold analysis, time-contrast curve analysis, and total variation analysis. One or more mask volumes and a plurality of contrast agent enhanced volumes are generated based on a plurality of projections generated using a moving C-arm X-ray device. A maximum contrast attenuation volume is generated based on the plurality of contrast agent enhanced volumes. Voxels are identified as streaks based on analyses applied to the one or more mask volumes, the plurality of contrast agent enhanced volumes, and the maximum contrast attenuation volume, respectively.

This application claims the benefit of Provisional Application Ser. No. 61/973,840, which is hereby incorporated by reference in its entirety.

### FIELD

The present embodiments relate to artifact removal within image data.

### BACKGROUND

Time attenuation curves (TACs) describe contrast flow in brain tissue and vessels and may be reconstructed from acquisitions with a C-arm X-ray device using a rotation angiography technique. The TACs are used to calculate brain perfusion maps (e.g., cerebral blood flow (CBF), cerebral blood volume (CBV) and/or mean transit time (MTT)). The brain perfusion maps provide information about the extent of stroke affected brain tissue.

Sampling of TACs uses time-resolved instantaneous acquisition over a period of time (e.g., >40 seconds). To avoid an overall high radiation dose to a patient, an applied dose may be minimized, and/or the sampling may be coarse. Resultant perfusion maps may, therefore, be noisy and include streak artifacts. The C-arm X-ray device may be rotated at high rotational speeds to provide sufficient temporal resolution, but a limited detector read-out rate may cause streak artifacts to occur in reconstructed volumes and may lead to artifacts in the brain perfusion maps.

### SUMMARY

In order to minimize streak artifacts within reconstructions of perfusion maps generated from moving C-arm acquisitions, a streak reduction method includes threshold analysis, time-contrast curve analysis, and total variation analysis. One or more mask volumes and a plurality of contrast agent enhanced volumes are generated based on a plurality of projections generated using a moving C-arm X-ray device. A maximum contrast attenuation volume is generated based on the plurality of contrast agent enhanced volumes. Voxels are identified as streaks based on analyses applied to the one or more mask volumes, the plurality of contrast agent enhanced volumes, and the maximum contrast attenuation volume, respectively.

In a first aspect, a method for artifact removal within image data is provided. The method includes identifying, by a processor, a first three dimensional (3D) dataset. The first 3D dataset includes image data representing an object without a contrast agent. The processor identifies a plurality of second 3D datasets. Each second 3D dataset of the plurality of second 3D datasets includes a plurality of voxels representing the object with the contrast agent. The processor generates a third 3D dataset based on the plurality of second 3D datasets. The processor categorizes a subset of data from the first 3D dataset. The categorized subset of data corresponds to a subset of voxels of the plurality of voxels. The processor generates time attenuation curves (TACs) based on the plurality of second 3D datasets. The processor identifies one or more artifacts within the third 3D dataset based on one or more thresholds and the generated TACs for voxels corresponding to locations of voxels of the subset. The processor removes the one or more identified artifacts from the third 3D dataset.

In a second aspect, a non-transitory computer-readable storage medium that stores instructions executable by one or more processors to identify and remove artifacts within computed tomography image data is provided. The instructions include generating a first 3D dataset. The first 3D dataset includes image data that represents an object without a contrast agent. The instructions also include generating a plurality of second 3D datasets. Each second 3D dataset of the plurality of second 3D datasets includes a plurality of voxels representing the object with the contrast agent. A third 3D dataset is generated based on maximum over the plurality of second 3D datasets for each voxel of the plurality of voxels. TACs are generated based on the plurality of second 3D datasets. One or more artifacts are identified within a subset of voxels of the third 3D dataset based on one or more thresholds and the generated TACs. The one or more identified artifacts are removed from the third 3D dataset.

In a third aspect, a system for artifact removal within image data is provided. The system includes a processor configured to identify a first 3D dataset. The first 3D dataset includes image data that represents an object without a contrast agent. The processor is further configured to identify a plurality of second 3D datasets. Each second 3D dataset of the plurality of second 3D datasets includes a plurality of voxels that represents the object with the contrast agent. The processor is further configured to generate a third 3D dataset based on a maximum over the plurality of second 3D datasets for each voxel of the plurality of voxels. The processor is further configured to segment a subset of data from the first 3D dataset. The segmented subset of data corresponds to a subset of voxels of the plurality of voxels. The processor is configured to generate TACs based on the plurality of second 3D datasets. The processor is further configured to identify one or more artifacts within the third 3D dataset based on one or more thresholds and the generated TACs for voxels corresponding to locations of voxels of the subset. The processor is configured to remove the one or more identified artifacts from the third 3D dataset. The system also includes a memory operatively connected to the processor. The memory is configured to store the third 3D dataset from which the one or more identified artifacts have been removed. The system includes a display operatively connected to the memory. The display is configured to display the third 3D dataset from which the one or more identified artifacts have been removed.

In a fourth aspect, a method for artifact removal within computed tomography (CT) image data is provided. The method includes generating, by a processor, a 3D dataset representing maximum contrast attenuation over time of a contrast agent in an object. The processor generates time attenuation curves (TACs) of the contrast agent in the object for voxels corresponding to the 3D data set. The processor identifies one or more streak artifacts in the 3D dataset based on one or more thresholds and the generated TACs. The processor further removes the one or more identified artifacts from the 3D dataset.

The present invention is defined by the following claims, and nothing in this section should be taken as a limitation on those claims. Further aspects and advantages of the embodiments are discussed below and may be later claimed independently or in combination.

### BRIEF DESCRIPTION OF THE DRAWINGS

FIG. 1 shows one embodiment of an imaging system;

FIG. 2 shows an imaging system including one embodiment of an imaging device;

FIG. 3 shows a flowchart of one embodiment of a method for artifact removal within image data; and

FIG. 4 shows exemplary time-contrast attenuation curves for a voxel representing an artery and for a voxel representing streak-affected brain tissue, respectively.

### DETAILED DESCRIPTION

Perfusion computed tomography (PCT) is an imaging modality for measuring blood flow in organs (e.g., liver or brain) and may be used for diagnosis. Below, examples will be provided for PCT in diagnosis of ischemic stroke in a brain, but the teachings may be used for measuring blood flow in other organs and/or for other conditions.

Time attenuation curves (TACs) in tissue and vessels are extracted from a time series of brain volumes acquired after a contrast bolus injection. Perfusion parameter maps calculated from TACs that represent quantities, such as cerebral blood flow (CBF), cerebral blood volume (CBV), mean transit time (MTT), and time-to-peak (TTP), provide information about the extent of the affected tissue. The maps may be used to identify potentially salvageable ischemic tissue that may be reperfused by stroke therapy procedure (e.g., catheter-guided intra-arterial thrombolysis).

Perfusion imaging being available on interventional C-arm systems may save time of moving the patient from a CT scanner room and may allow intraoperative imaging to determine treatment success and treatment endpoint. Perfusion C-arm CT (PCCT) may allow acquisition of 3D perfusion maps in high resolution in an axial direction with full brain coverage.

A high speed scanning protocol using a robotic C-arm system (e.g., Artis Zeego, Siemens AG) with increased rotation speed of up to 100°/s or 120°/s, for example, may be used to improve temporal sampling of the TACs. Due to limitations in detector read out rate, angular sampling of projection data in high speed scanning may be coarse, which leads to streak artifacts in reconstructed volumes.

Since mask volumes are subtracted from contrast agent enhanced volumes to compute pure contrast agent enhancement volumes, streak artifacts are subtracted out. A patient, however, may move during acquisition. Streak artifacts may thus not be in identical positions in the mask and the contrast-enhanced volumes, so may be visible in the pure contrast agent volumes due to improper cancellation.

The high speed scanning protocol may include twelve or another number of alternating C-arm rotations. In one embodiment, the first two rotations acquire mask volumes with static anatomical structures in forward and backward C-arm rotation before bolus injection. The following ten consecutive rotations after bolus injection acquire a time series of contrast agent enhanced volumes in alternating forward and backward C-arm rotation. Other protocols may be used, such as with only forward or only backward C-arm rotation during scanning. Other numbers of mask and/or contrast volumes may be acquired over any period.

All mask and contrast acquisitions are reconstructed using the Feldkamp (FDK) algorithm. A non-smoothing Shepp-Logan filter kernel is used to preserve the edges around high contrast vessels. To compensate for head motion during the acquisition, all reconstructed volumes are registered to the forward mask volume using 3D-3D rigid registration. The reconstructed mask volumes are subtracted from the contrast-enhanced volumes, and the subtracted volumes are registered to the forward mask volume using 3D-3D rigid registration. The reconstructed mask volumes are subtracted from the contrast-enhanced volumes to obtain the volumes describing the pure contrast agent enhancement over time.

A guidance volume M is computed by finding a peak contrast agent attenuation over all pure contrast volumes for each voxel. The collection of maximum values for the voxels is used as the guidance volume M. The guidance volume M is denoised by bilateral filtering with range variance and domain variance. The pure contrast volumes are denoised by joint bilateral filtering (JBF) of each volume with range variance and domain variance. The JBF corresponds to bilateral filtering, where the range similarity is computed using the guidance volume M. Other filtering or no filtering may be used.

The guidance volume M is updated by recomputing peaks from the filtered contrast agent enhanced volumes. This JBF before streak removal generates data with sufficient contrast-to-noise ratio (CNR) for a TAC analysis.

In addition to high contrasted vessels, the guidance volume M may contain edges due to streak artifacts. If these false edges are not detected and removed, the false edges may be translated to the filtered contrast volumes. Voxels that are affected by streaks are identified by analysis intensity and TACs of the voxels. Brain tissue is therefore identified by segmenting the forward mask volume into air, bone, and tissue based on thresholding. Voxels with a radiodensity below τ_{Air} are classified as air, voxels with a radiodensity above τ_{Bone} are classified as bone, and the remaining voxels are classified as brain tissue.

Streaks and vessels are identified within voxels corresponding to the brain tissue by thresholding the guidance volume M followed by time curve analysis. If a tissue voxel in M is below τ_{M}_{_{—}}ₘᵢₙ≦0, the tissue voxel is classified as streak. No negative radiodensity values are expected in the contrast attenuation peaks, except slightly negative values due to noise or registration errors. If a tissue voxel in M has a large intensity above τ_{M}_{_{—}}ₘₐₓ, the tissue voxel may be either a vessel or a streak. To differentiate between vessels and streaks, the TACs are analyzed. Vessels have typical TACs with a monotonic increase up to a clear contrast peak, and possibly a second smaller peak due to a second pass of contrast agents, while streaks may produce irregular TACs.

A difference between a peak value to a value from which a monotonic increase to the peak starts is denoted as uptake μ. To differentiate streaks and vessels, a voxel is identified as a vessel if a corresponding TAC has 1) a single global peak with an uptake μ_{global} of at least 70% of the peak value; and 2) no further peak with an uptake μ_{local} of more than 30% of the global peak uptake μ_{global}. Otherwise, the voxel is classified as streak. Voxels of all other intensities are classified as streaks if the voxels have a total variation (TV) above τ_{TV}.

A final brain segmentation (e.g., categorization) is generated by combining the detected streaks and vessels. A dilation operation is applied on segmented vessels using, for example, a 2D rectangular element of size 2×2 voxels. The dilation of the vessels provides that the vessel edges are preserved in the streak removal. An erosion (1×2 element) followed by dilation (2×2 element) operation is applied to the streak mask to remove outliers and close gaps in the detected streak areas.

The brain segmentation is created by combining the vessel and streak masks with the initial brain tissue segmentation. If after dilation, one voxel is identified as streak and vessel, the one voxel is classified as vessel. The identified streaks are removed with a truncated Gaussian kernel averaging over spatially close tissue voxels that are not classified as vessels (i.e., average streak voxels). Two further JBF denoising iterations are applied to smooth the streaks out of the pure contrast volumes and for further noise reduction. After reconstruction, TACs sampled in intervals (e.g., 1 second intervals) are generated from the reconstructed pure contrast volumes by interpolation (e.g., cubic spline interpolation), and an appropriate arterial function (AIF) is selected manually.

The noise reduction combined with Feldkamp reconstruction followed by iterative denoising in volume space provides computationally fast and effective denoising in volume space. The streak reduction using time-constant curve analysis and total variation computation may avoid the streak artifacts that occur in reconstructions of high speed acquisitions in the case of patient movement. Other reconstruction, denoising, and total variation computation may be used.

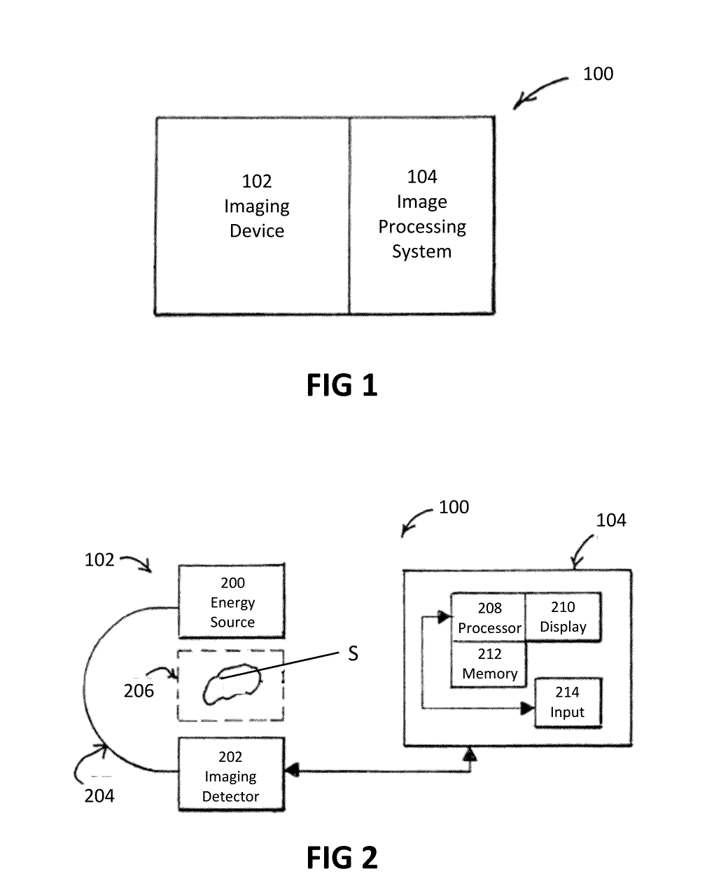

FIG. 1 shows one embodiment of an imaging system 100. The imaging system is representative of an imaging modality. The imaging system 100 includes one or more imaging devices 102 and an image processing system 104. A two-dimensional (2D) or a three-dimensional (3D) (e.g., volumetric) image dataset may be acquired using the imaging system 100. The 2D image data set or the 3D image data set may be obtained contemporaneously with the planning and execution of a medical treatment procedure or at an earlier time. Additional, different, or fewer components may be provided.

The imaging device 102 includes a C-arm X-ray device (e.g., a C-arm angiography X-ray device). Alternatively or additionally, the imaging device 102 may also include a gantry-based X-ray system, a magnetic resonance imaging (MRI) system, an ultrasound system, a positron emission tomography (PET) system, a single photon emission computed tomography (SPECT) system, an angiography system, a fluoroscopy, another X-ray system, any other now known or later developed imaging systems, or a combination thereof. The image processing system 104 is a workstation, a processor of the imaging device 102, or another image processing device. The imaging system 100 may be used to generate time attenuation curves (TACs) describing contrast agent flow in brain tissue and vessels. For example, the image processing system 104 is a workstation for generating TACs describing contrast flow in brain tissue and vessels using data from the imaging device 102. The TACs may be created from data generated by the one or more imaging devices 102 (e.g., a C-arm angiography device or a CT device). The workstation receives data representing the brain with or without tissue surrounding the brain, for example, generated by the one or more imaging devices 102.

FIG. 2 shows the imaging system 100 including one embodiment of the imaging device 102. The imaging device 102 is shown in FIG. 2 as a C-arm X-ray device. The imaging device 102 may include an energy source 200 and an imaging detector 202 connected together by a C-arm 204. Additional, different, or fewer components may be provided. In other embodiments, the imaging device 102 may be, for example, a gantry-based CT device.

The energy source 200 and the imaging detector 202 may be disposed opposite each other. For example, the energy source 200 and the imaging detector 202 may be disposed on diametrically opposite ends of the C-arm 204. Arms of the C-arm 204 may be configured to be adjustable lengthwise, so that the energy source 200 and the imaging detector 202 may be positioned optimally in a ring structure. In certain embodiments, the C-arm 204 may be movably attached (e.g., pivotably attached) to a displaceable unit. The C-arm 204 may be moved on a buckling arm robot. The robot arm allows the energy source 200 and the imaging detector 202 to move on a defined path around the patient. During acquisition of the non-contrast and contrast scans, the C-arm 204 is swept around the patient. During the contrast scans, contrast agent may be injected intravenously. In another example, the energy source 200 and the imaging detector 202 are connected inside a gantry.

High rotation speeds may be attained with the C-arm X-ray device 102. In one embodiment, the C-arm X-ray device is operable to rotate up to 100 Vs or 120 Vs (e.g., Artis Zeego, Siemens AG). In other embodiments, one complete scan (e.g., a 200 degree rotation) of the high speed C-arm X-ray device 102 may be conducted in less than 5 seconds, less than 3 seconds, less than 2 seconds, less than 1 second, less than 0.5 seconds, less than 0.1 seconds, approximately 5 seconds, approximately 3 seconds, approximately 2 seconds, approximately 1 second, approximately 0.5 seconds, approximately 0.1 seconds, between 0.1 and 5 seconds, between 1 and 3 seconds, between 2 and 3 seconds, between 1 and 2 seconds, between 0.5 and 1 second, or between 0.1 and 1 second.

The energy source 200 may be a radiation source such as, for example, an X-ray source. The energy source 200 may emit radiation to the imaging detector 202. The imaging detector 202 may be a radiation detector such as, for example, a digital-based X-ray detector or a film-based X-ray detector. The imaging detector 202 may detect the radiation emitted from the energy source 200. Data is generated based on the amount or strength of radiation detected. For example, the imaging detector 202 detects the strength of the radiation received at the imaging detector 202 and generates data based on the strength of the radiation. The data may be considered imaging data as the data is used to then generate an image. Image data may also include data for a displayed image.

During each rotation, the high speed C-arm X-ray device 102 may acquire between 50-500 projections, between 100-200 projections, or between 100-150 projections. In other embodiments, during each rotation, the C-arm X-ray device 102 may acquire between 50-100 projections per second, or between 50-75 projections per second. In certain embodiments, the projections may be acquired at 70 kVp and 1.2 Gy/frame dose level, with automatic exposure control enabled for the duration of the acquisition with a bit-depth of 14 bits. Any speed, number of projections, dose levels, or timing may be used.

A region 206 to be examined (e.g., the brain of a patient) is located between the energy source 200 and the imaging detector 202. The size of the region 206 to be examined may be defined by an amount, a shape, or an angle of radiation. The region 206 to be examined may include one or more structures S (e.g., one or more volumes of interest), for which the TACs are to be calculated. The region 206 may be all or a portion of the patient. The region 206 may or may not include a surrounding area. For example, the region 206 to be examined may include the brain and/or other organs or body parts in the surrounding area of the brain.

The data may represent a two-dimensional (2D) or three-dimensional (3D) region, referred to herein as 2D data or 3D data. For example, the C-arm X-ray device 102 may be used to obtain 2D data or CT-like 3D data. A computer tomography (CT) device may obtain 2D data or 3D data. In another example, a fluoroscopy device may obtain 3D representation data. The data may be obtained from different directions. For example, the imaging device 102 may obtain data representing sagittal, coronal, or axial planes or distribution.

The imaging device 102 may be communicatively coupled to the image processing system 104. The imaging device 102 may be connected to the image processing system 104, for example, by a communication line, a cable, a wireless device, a communication circuit, and/or another communication device. For example, the imaging device 102 may communicate the data to the image processing system 104. In another example, the image processing system 104 may communicate an instruction such as, for example, a position or angulation instruction to the imaging device 102. All or a portion of the image processing system 104 may be disposed in the imaging device 102, in the same room or different rooms as the imaging device 102, or in the same facility or in different facilities.

All or a portion of the image processing system 104 may be disposed in one imaging device 102. The image processing system 104 may be disposed in the same room or facility as one imaging device 102. In one embodiment, the image processing system 104 and the one imaging device 102 may each be disposed in different rooms or facilities. The image processing system 104 may represent a plurality of image processing systems associated with more than one imaging device 102.

In the embodiment shown in FIG. 2, the image processing system 104 includes a processor 208, a display 210 (e.g., a monitor), and a memory 212. Additional, different, or fewer components may be provided. For example, the image processing system 104 may include an input device 214, a printer, and/or a network communications interface.

The processor 208 is a general processor, a digital signal processor, an application specific integrated circuit, a field programmable gate array, an analog circuit, a digital circuit, another now known or later developed processor, or combinations thereof. The processor 208 may be a single device or a combination of devices such as, for example, associated with a network or distributed processing. Any of various processing strategies such as, for example, multi-processing, multi-tasking, and/or parallel processing may be used. The processor 208 is responsive to instructions stored as part of software, hardware, integrated circuits, firmware, microcode or the like.

The processor 208 may generate an image from the data. The processor 208 processes the data from the imaging device 102 and generates an image based on the data. For example, the processor 208 may generate one or more angiographic images, fluoroscopic images, top-view images, in-plane images, orthogonal images, side-view images, 2D images, 3D representations (e.g., renderings or volumes), progression images, multi-planar reconstruction images, projection images, or other images from the data. In another example, a plurality of images may be generated from data detected from a plurality of different positions or angles of the imaging device 102 and/or from a plurality of imaging devices 102.

The processor 208 may generate a 2D image from the data. The 2D image may be a planar slice of the region 206 to be examined. For example, the C-arm X-ray device 102 may be used to detect data that may be used to generate a sagittal image, a coronal image, and an axial image. The sagittal image is a side-view image of the region 206 to be examined. The coronal image is a front-view image of the region 206 to be examined. The axial image is a top-view image of the region 206 to be examined.

The processor may generate a 3D representation from the data. The 3D representation illustrates the region 206 to be examined. The 3D representation may be generated from a reconstructed volume (e.g., by combining 2D images) obtained by the imaging device 102 from a given viewing direction. For example, a 3D representation may be generated by analyzing and combining data representing different planes through the patient, such as a stack of sagittal planes, coronal planes, and/or axial planes. Additional, different, or fewer images may be used to generate the 3D representation. Generating the 3D representation is not limited to combining 2D images. For example, any now known or later developed method may be used to generate the 3D representation.

The processor 208 may display the generated images on the monitor 210. For example, the processor 208 may generate the 3D representation and communicate the 3D representation to the monitor 210. The processor 208 and the monitor 210 may be connected by a cable, a circuit, another communication coupling or a combination thereof. The monitor 210 is a monitor, a CRT, an LCD, a plasma screen, a flat panel, a projector or another now known or later developed display device. The monitor 210 is operable to generate images for a two-dimensional view or a rendered three-dimensional representation. For example, a two-dimensional image representing a three-dimensional volume through rendering is displayed.

The processor 208 may communicate with the memory 212. The processor 208 and the memory 212 may be connected by a cable, a circuit, a wireless connection, another communication coupling, or a combination thereof. Images, data, and other information may be communicated from the processor 208 to the memory 212 for storage, and/or the images, the data, and the other information may be communicated from the memory 212 to the processor 208 for processing. For example, the processor 208 may communicate the generated images, image data, or other information to the memory 212 for storage.

The memory 212 is a computer readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 212 may be a single device or a combination of devices. The memory 212 may be adjacent to, part of, networked with and/or remote from the processor 208.

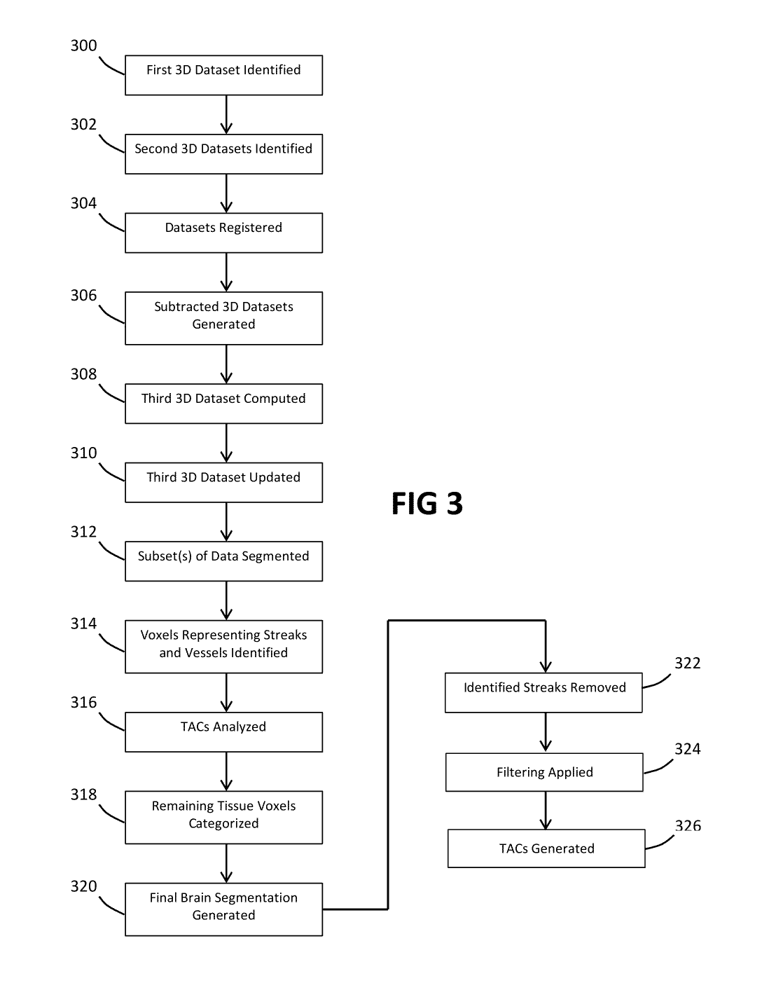

FIG. 3 shows a flowchart of one embodiment of a method for artifact removal within image data. The image data may, for example, be computed tomography (CT) image data or image data generated during rotation of a C-arm during X-ray imaging. The method may be performed using the imaging system 100 shown in FIGS. 1 and 2 (e.g., at least some of the acts of the method may be performed by the processor 208) or another imaging system. For example, the acts of the method are implemented by one or more processors using instructions from one or more memories. The method is implemented in the order shown, but other orders may be used. Additional, different, or fewer acts may be provided. Similar methods may be used for artifact removal within image data.

In act 300, a first 3D dataset (e.g., a mask volume) is identified by a processor. The first 3D dataset includes image data representing an object without a contrast agent injected into the object. The object may be, for example, the brain of a patient. The object may also include tissue, bone, and air surrounding the brain of the patient. In other embodiments, the object includes one or more other or different body parts or organs of the patient. The processor may identify more than one first 3D dataset.

An X-ray device generates each projection of a plurality of first projections without a contrast agent injected into the object over an angular range. The X-ray device may be a C-arm X-ray device, and the angular range may be an angular range of a C-arm of the C-arm X-ray device. The angular range may, for example, be 200° in a forward rotation of the C-arm X-ray device. The C-arm X-ray device may rotate at high speeds (e.g., 100°/s). In one embodiment, the C-arm X-ray device generates a plurality of first projections over a plurality of angular ranges. For example, the C-arm X-ray device may generate a plurality of first projections over a forward angular range of 200° (e.g., for a forward first 3D dataset) and may generate a plurality of first projections over a backward angular range of 200° (e.g., for a backward first 3D dataset). In one embodiment, each rotation acquires 133 projections over a 200° angular range and requires 2.8 s for data acquisition with a pause of 1.2 s between any two successive rotations. The plurality of first projections may be stored in a memory in communication with the processor.

The processor generates the first 3D dataset (e.g., the one or more first 3D datasets) based on the plurality of first projections. The processor may reconstruct the first 3D dataset using the Feldkamp algorithm, for example. A Feldkamp algorithm is described in, for example, “Practical cone-beam algorithm,” by L. A. Feldkamp et al., in J. Opt. Soc. Am. A, Vol. 1, No. 6, June 1984. Other reconstruction algorithms may be used. The processor may apply a filter to preserve edges around high contrast vessels within the first 3D dataset. In one embodiment, a non-smoothing Shepp-Logan filter kernel is used to preserve the edges. Other filters may be used. A non-smoothing Shepp-Logan filter kernel is further described in “The Fourier Reconstruction of a Head Section,” by L. A. Shepp and B. F. Logan, in IEEE Transactions on Nuclear Science, Vol. NS-21, June 1974. No filtering may be provided.

The result of the reconstruction with or without filtering is a volumetric data set representing X-ray attenuation values associated with a plurality of individual small volumes (e.g., voxels) of the object that has been imaged (e.g., the volume that has been imaged). The voxels represent an N×M×O region of the object, where N, M, and O are all greater than or equal to 1 in a rectangular grid. Other grids may be used. The first 3D dataset may be stored in the memory once the first 3D dataset is generated by the processor. In act 300, the processor may identify an already reconstructed first 3D dataset stored in the memory or may identify by performing the reconstruction.

In act 302, a plurality of second 3D datasets (e.g., contrast agent enhanced volumes) are identified by the processor. Each second 3D dataset of the plurality of second 3D datasets includes a plurality of voxels representing the object with the contrast agent injected.

The C-arm X-ray device or another imaging device generates a plurality of second projections with a contrast agent injected into the object over a plurality of angular ranges. The contrast agent may be administered to or injected into the patient either venously or arterially. The angular ranges may, for example, be 200° in successive forward and backward rotations of the C-arm X-ray device. For example, the C-arm X-ray device may generate the plurality of second projections over ten successive forward and backward angular ranges of 200°. In one embodiment, each rotation acquires 133 projections over a 200° angular range and requires 2.8 s for data acquisition with a pause of 1.2 s between any two successive rotations. The plurality of second projections may be stored in a memory in communication with the processor.

The processor generates the plurality of second 3D datasets based on the plurality of second projections. The processor may reconstruct the plurality of second 3D datasets using the Feldkamp algorithm, for example. Other reconstruction algorithms may be used. The processor may apply a filter to preserve edges around high contrast vessels within the plurality of second 3D datasets. In one embodiment, a non-smoothing Shepp-Logan filter kernel is used to preserve the edges. Other filters or no filtering may be used.

The result of the reconstructions is a plurality of volumetric data sets representing X-ray attenuation values associated with a plurality of voxels representing the object that has been imaged. Each data set represents the object volume at a different time. The plurality of second 3D datasets may be stored in the memory once the plurality of second 3D datasets is generated by the processor. In act 302, the processor may identify already reconstructed second 3D datasets stored in the memory or by reconstructing the data sets.

In act 304, the processor registers each dataset of the plurality of second 3D datasets and any other first 3D datasets (e.g., the backward first 3D dataset) with the first 3D dataset identified in act 300 (e.g., the forward first 3D dataset). The plurality of second 3D datasets and the backward first 3D dataset may be registered with the forward first 3D dataset in any number of ways including, for example, using 3D-3D rigid registration. Other registration methods may be used. Other data sets may be used as the reference (i.e., register to a different data set). The registration spatially aligns the data sets to counter any motion that occurs between acquisitions of the data sets. The spatial transform for the registration may be rigid or non-rigid.

In act 306, the processor generates subtracted 3D datasets from the spatially registered data sets. The processor may generate the subtracted 3D datasets (e.g., volumes describing pure contrast enhancement over time) by subtracting the first 3D dataset and/or any other first 3D datasets from the plurality of second 3D datasets. The masking data sets (e.g., the forward and backward first 3D datasets) may be combined, such as averaged, and the combined data set may be used in the subtraction. The masking dataset is separately subtracted from each or some of the contrast agent enhanced datasets, resulting in a set of subtracted 3D datasets. The subtracted 3D datasets represent volumes describing pure contrast agent enhancement over time since the mask information (i.e., volume without contrast agent) is subtracted. The subtracted datasets may include streak artifacts.

In act 308, the processor computes a third 3D dataset (e.g., a guidance volume M). The processor computes the third 3D dataset by determining a peak contrast attenuation based on the plurality of second 3D datasets (e.g., over all second 3D datasets of the plurality of second 3D datasets) for each voxel of the plurality of voxels. For example, the processor computes the third 3D dataset by determining a maximum voxel value over all of the subtracted 3D datasets for each voxel of the plurality of voxels. In other words, each of the subtracted 3D datasets may include, for example, a first voxel of a plurality of voxels. Due to registration of the subtracted 3D datasets, each of the first voxels represents a same position. The processor determines a maximum voxel value of the first voxels. The value of the first voxel of the third 3D dataset (e.g., representing the same position as each of the first voxels of the subtracted 3D datasets) is set to equal the maximum voxel value of the first voxels of the subtracted 3D datasets. The same process may be applied for the other voxels of the plurality of voxels.

The third 3D dataset is denoised using bilateral filtering with range variance σ_{RD}² (e.g., 120 HU) and domain variance σ_{D}² (e.g., 1.5 voxel). Bilateral filtering is described in greater detail in “Non-linear Gaussian filters performing edge preserving diffusion,” by V. Aurich and J. Weule, in Proc. DAGM-Symposium Mustererkennung, vol. 17, pp. 538-545, 1995, and “Bilateral filtering for gray and color images,” by C. Tomasi and R. Manduchi, in Proc. 6^{th} IEEE ICCV, 1998, pp. 839-846. Other or no filtering may be used.

The subtracted 3D datasets are denoised by joint bilateral filtering of each of the subtracted 3D datasets. The subtracted 3D datasets are denoised with range variance σ_{R}² (e.g., 10 HU) and domain variance σ_{D}². The range similarity is computed using the third 3D dataset. Other or no filtering may be used.

In act 310, the processor updates the third 3D dataset using peak contrast attenuations from the filtered subtracted 3D datasets from act 308. The denoising provided in act 308 may generate data with sufficient contrast-to-noise ratio for TAC analysis. In addition to high contrast vessels, the third 3D dataset may include edges due to streak artifacts. If these false edges are not detected and removed, the false edges may be translated to the filtered subtracted 3D datasets.

In the acts described below, at least some of the voxels of the mask volume are categorized as brain tissue, bone, and air. Within the voxels categorized as brain tissue, voxels representing vessels (e.g., a vessel mask) and voxels representing streaks (e.g., a streak mask) are identified. Voxels affected by streaks may be identified based on intensity and TACs.

In act 312, the processor segments one or more subsets of data from the first 3D dataset (e.g., categorizes one or more subsets of data within the first 3D dataset). A subset of data of the one or more subsets represents brain tissue. Other subsets of data of the one or ore subsets may represent bone and air, respectively. Each voxel of the plurality of voxels is categorized as representing air, bone, or tissue based on thresholding. In one embodiment, only some voxels of the plurality of voxels are categorized. The processor categorizes voxels with a radiodensity below τ_{Air} (e.g., −800 HU) as air and categorizes voxels with a radiodensity above τ_{Bone} (e.g., 350 HU) as bone. The thresholds τ_{Air} and τ_{Bone} may be determined experimentally and/or may be stored within the memory or another memory. Alternatively, the thresholds τ_{Air} and τ_{Bone} may be received by the processor from a user of the C-arm imaging device via a user input. The processor may segment voxels not categorized as air or bone (e.g., tissue voxels) from the first 3D dataset. The processor may categorize the voxels not categorized as air or bone as voxels representing tissue.

In act 314, the processor identifies, within the updated third 3D dataset generated in act 310, a portion of voxels, which corresponds to a portion of the segmented tissue voxels from act 312, that represents one or more streaks (e.g., streak artifacts) based on thresholding. The processor classifies a tissue voxel in the updated third 3D dataset as a streak when the radiodensity of the tissue voxel in the updated third 3D dataset is below τ_{M}_{_{—}}ₘᵢₙ (e.g., −5 ΔHU), which may be less than or equal to zero. The threshold τ_{M}_{_{—}}ₘᵢₙ may be determined experimentally and/or may be stored within the memory or another memory. Alternatively, the threshold τ_{M}_{_{—}}ₘᵢₙ may be received by the processor from the user of the C-arm imaging device via the user input. Other than slightly negative values due to noise or registration errors, negative radiodensity values are not expected in the contrast attenuation peaks.

When a tissue voxel in the updated third 3D dataset has a large radiodensity value, above τ_{M}_{_{—}}ₘₐₓ, the tissue voxel in the updated third 3D dataset may be either a vessel or a streak. The threshold τ_{M}_{_{—}}ₘₐₓ may be determined experimentally and/or may be stored within the memory or another memory. Alternatively, the thresholds τ_{Air} and τ_{Bone} may be received by the processor from the user of the C-arm imaging device via the user input.

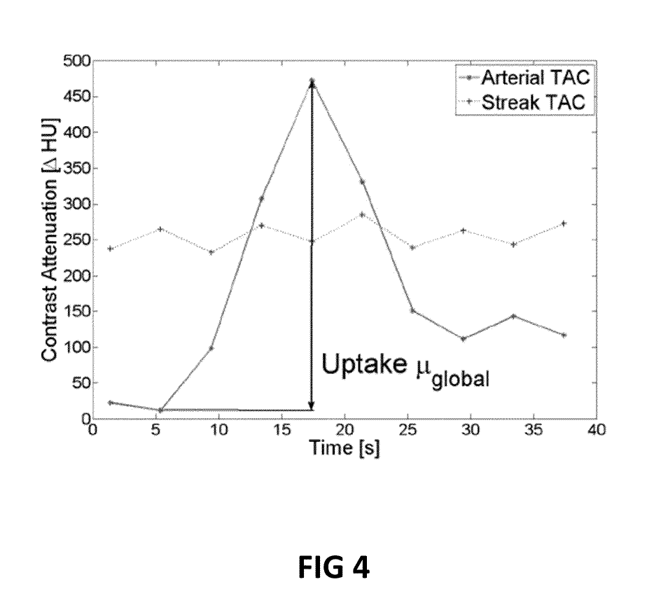

In act 316, the processor differentiates between vessels and streak artifacts in the voxels with a radiodensity above threshold τ_{M}_{_{—}}ₘₐₓ (e.g., 150 ΔHU) in the updated third 3D dataset identified in act 314. The processor differentiates between vessels and streak artifacts in these voxels by analyzing TACs generated for each of the voxels based on the subtracted 3D datasets after filtering. Vessels may produce TACs with a monotonic increase up to a clear contrast peak and possibly a second smaller peak due to second pass. Streaks may produce more irregular TACs compared to vessels. A difference between a peak value of the TAC to a value from which the monotonic increase to the peak value begins is denoted as uptake μ. FIG. 4 shows exemplary time-contrast attenuation curves for a voxel representing an artery and for a voxel representing streak-affected brain tissue. FIG. 4 also illustrates an exemplary uptake μ. The value from which the monotonic increase to the peak begins may be determined by a slope analysis or in other ways. In one embodiment, the value from which the monotonic increase to the peak begins may be determined by moving along the TAC from the peak until the value along the TAC no longer decreases. This value, where the TAC no longer decreases, may be the value from which the monotonic increase to the peak begins.

The processor identifies a tissue voxel as being a vessel if the TAC corresponding to the tissue voxel has: 1) a single global peak (e.g., a global maximum) with an uptake μ_{global} of at least v_{global}=70% of the peak value; and 2) no further peak (e.g., a local maximum) with an uptake μ_{local} of more than v_{local}=30% of the global peak uptake μ_{local}. Different percentages may be used to identify the tissue voxels as being vessels. Tissue voxels that are not identified as being a vessel are categorized as streaks.

In act 318, the processor categorizes tissue voxels of other intensities (e.g., remaining tissue voxels) as streaks if the tissue voxels have a total variation (TV) above τ_{TV}. The processor determines TVs for the remaining tissue voxels within the updated third 3D dataset, and categorizes at least some of the remaining tissue voxels based on the determined TVs. The processor may calculate TV for each of the remaining tissue voxels by determining energy in the gradients in some or all directions (e.g., six directions). TV is further described in the context of denoising and reconstruction in “Nonlinear total variation based noise removal algorithms,” by Leonid I Rudin, et al., in Physica D 60, 1992, 259-268. The threshold τ_{TV} (e.g., 150 ΔHU) may be determined experimentally and/or may be received by the processor from a user of the C-arm imaging device via a user input.

In act 320, the processor generates a final brain segmentation. The final brain segmentation is generated by combining the tissue voxels categorized as streaks (e.g., the streak mask) with the tissue voxels categorized as vessels (e.g., the vessel mask). The processor performs a dilation operation on vessel mask using, for example, a 2D rectangular element of size 2×2 voxels. The dilation of the vessels provides that the vessel edges are preserved during streak removal. The processor then performs an erosion (e.g., 1×2 voxels) followed by dilation (e.g., 2×2 voxels) to the streak mask to remove single outliers and close gaps in the detected streak areas. The final brain segmentation (e.g., categorization) is generated by combining the vessel and streak masks with the initial brain tissue segmentation (e.g., categorization) from act 312. In one embodiment, if after dilation, one voxel is identified as streak and vessel, the one voxel is classified as vessel.

In act 322, the processor removes identified streaks from the updated third 3D dataset. The processor may remove the identified streaks using, for example, a truncated Gaussian kernel averaging over spatially close tissue voxels that are not classified as vessels. For example, the value for a voxel identified as a streak is changed to equal an average of the values for spatially close tissue voxels (e.g., using truncated Gaussian kernel averaging). Other methods of removing the streaks may be used.

In act 324, two further joint bilateral filtering denoising iterations (e.g., as described above with respect to act 308) are applied to smooth the identified streaks out of the subtracted 3D datasets and for further noise reduction. Other numbers of iterations may be used. The third 3D dataset is again updated based on the plurality of filtered second 3D datasets. The subtracted 3D datasets are again denoised by joint bilateral filtering of each of the subtracted 3D datasets using the third 3D dataset.

In act 326, the processor generates TACs from the filtered subtracted 3D datasets from act 324. The TACs may be sampled in 1 s intervals, for example, using interpolation. The TACs generated in act 326 may not include streak artifacts or may include fewer streak artifacts, and thus, parameter maps calculated from the TACs may more accurately represent quantities such as CBF, CBV, MTT, and TTP.

CBF measures the blood supply to a segment of the brain in a given time. CBF may be calculated from the cerebral blood volume divided by the MTT for a defined segment of tissue. Based upon the calculated CBF, the location of an ischemic stroke may be determined. For example, in an adult, a healthy CBF is approximately 50 to 54 milliliters of blood per 100 grams of brain tissue per minute. Too little blood flow (e.g., ischemia) is generally identified as blood flow rates below 18 to 20 ml per 100 g per minute.

CBV describes the volume of blood actually present in a volume of imaged tissue. MTT measures the time required for blood to pass through a defined amount of tissue. Based on known injection scan times and contrast injection rates or tracers injected in the contrast, imaged tissue within reconstructed 3D data sets may be analyzed to determine the MTT for a specific tissue segment. Additionally, the MTT for the specific tissue segment may be compared with known transit times for healthy tissue segments. Abnormal MTT (e.g., slower than normal transit times) may indicate a location of the ischemic stroke.

TTP measures the time interval between administration of a contrast agent and the time the contrast agent reaches a highest concentration in a specific area of interest. Similar to MTT, based on known injection scan times and contrast injection rates, tissue within reconstructed 3D data sets may be analyzed to determine the TTP for a specific tissue segment. Ischemic locations may be identified by a delay of a contrast tracer arrival and an increase in the TTP.

In the case of pure FDK reconstruction, the data is denoised after arterial input function (AIF) selection by filtering spatially using a 2D Gaussian kernel with domain variance σ_{G}² (e.g., 2 voxels). CBF and CBV maps are computed using a deconvolution-based approach.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for artifact removal within image data, the method comprising:
identifying, by a processor, a first three dimensional (3D) dataset, the first 3D dataset comprising image data representing an object without a contrast agent;
identifying, by the processor, a plurality of second 3D datasets, each second 3D dataset of the plurality of second 3D datasets comprising a plurality of voxels representing the object with the contrast agent;
generating, by the processor, a third 3D dataset based on the plurality of second 3D datasets;
segmenting, by the processor, a subset of data from the first 3D dataset, the segmented subset of data corresponding to a subset of voxels of the plurality of voxels;
generating, by the processor, time attenuation curves (TACs) based on the plurality of second 3D datasets;
identifying, by the processor, one or more artifacts within the third 3D dataset based on one or more thresholds and the generated TACs for voxels corresponding to locations of voxels of the subset; and
removing, by the processor, the one or more identified artifacts from the third 3D dataset.

2. The method of claim 1, wherein the identifying of the one or more artifacts comprises classifying a first portion of voxels and a second portion of voxels within the subset of voxels of the third 3D dataset based on at least two radiodensity thresholds.

3. The method of claim 2, wherein the classifying is based on a difference between a peak value and a value from which an increase to the peak value begins for each of the TACs.

4. The method of claim 3, wherein the classifying is based on a total variation threshold.

5. The method of claim 3, wherein the first portion of voxels is classified as data representing the one or more artifacts, and the second portion of voxels is classified as data representing vessels.

6. The method of claim 5, further comprising combining the first portion of voxels and the second portion of voxels, the combining comprising performing a dilation operation on the second portion of voxels, and performing an erosion operating and a dilation operation on the first portion of voxels.

7. The method of claim 1, wherein the removing comprises smoothing with a truncated Gaussian kernel averaging.

8. The method of claim 1, wherein the segmenting comprises categorizing data of the first 3D dataset based on two radiodensity thresholds, the categorized data comprising a first portion of data, a second portion of data, and a third portion of data, and
wherein the first portion of data represents air, the second portion of data represents bone, and the third portion of data represents brain tissue.

9. The method of claim 8, wherein the segmented subset of data from the first 3D dataset corresponds to the categorized third portion of data

10. The method of claim 1, further comprising generating a plurality of fourth 3D datasets, the generating of the plurality of fourth 3D datasets comprising subtracting the first 3D dataset from each second 3D dataset of the plurality of second 3D datasets,
wherein generating the third 3D dataset comprises generating the third 3D dataset based on a maximum contrast attenuation across the plurality of fourth 3D datasets for each voxel of the plurality of voxels.

11. In a non-transitory computer-readable storage medium that stores instructions executable by one or more processors to identify and remove artifacts within image data, the instructions comprising:
generating a first three dimensional (3D) dataset, the first 3D dataset comprising image data representing an object without a contrast agent;
generating a plurality of second 3D datasets, each second 3D dataset of the plurality of second 3D datasets comprising a plurality of voxels representing the object with the contrast agent;
generating a third 3D dataset based on a maximum over the plurality of second 3D datasets for each voxel of the plurality of voxels;
generating time attenuation curves (TACs) based on the plurality of second 3D datasets;
identifying one or more artifacts within a subset of voxels of the third 3D dataset based on one or more thresholds and the generated TACs; and
at least partially removing the one or more identified artifacts from the third 3D dataset.

12. The non-transitory computer-readable storage medium of claim 11, wherein the instructions further comprise registering the plurality of second 3D datasets with the first 3D dataset.

13. The non-transitory computer-readable storage medium of claim 12, wherein the instructions further comprise generating subtracted 3D datasets, the generating of the subtracted 3D datasets comprising subtracting the first 3D dataset from each second 3D dataset of the plurality of second 3D datasets,
wherein generating the third 3D dataset comprises generating the third 3D dataset based on the maximum contrast attenuation over the subtracted 3D datasets for each voxel of the plurality of voxels.

14. The non-transitory computer-readable storage medium of claim 13, wherein the instructions further comprise:
generating an initial third 3D dataset based on maximum contrast attenuation over the plurality of subtracted 3D datasets for each voxel of the plurality of voxels;
denoising the initial third 3D dataset;
denoising the subtracted 3D datasets; and
generating an updated third 3D dataset based on maximum contrast attenuation over the plurality of denoised subtracted 3D datasets for each voxel of the plurality of voxels,
wherein the updated third 3D dataset corresponds to the third 3D dataset.

15. The non-transitory computer-readable storage medium of claim 14, wherein the denoising of the initial third 3D dataset comprises bilateral filtering, and
wherein the denoising of the subtracted 3D datasets comprises bilateral filtering, the bilateral filtering of the subtracted 3D datasets being based on the initial third 3D dataset.

16. A system for artifact removal within computed tomography (CT) image data, the system comprising:
a processor configured to:
identify a first three dimensional (3D) dataset, the first 3D dataset comprising image data representing an object without a contrast agent;
identify a plurality of second 3D datasets, each second 3D dataset of the plurality of second 3D datasets comprising a plurality of voxels representing the object with the contrast agent;
generate a third 3D dataset based on a maximum over the plurality of second 3D datasets for each voxel of the plurality of voxels;
segment a subset of data from the first 3D dataset, the segmented subset of data corresponding to a subset of voxels of the plurality of voxels;
generate time attenuation curves (TACs) based on the plurality of second 3D datasets;
identify one or more artifacts within the third 3D dataset based on one or more thresholds and the generated TACs for voxels corresponding to locations of voxels of the subset; and
remove the one or more identified artifacts from the third 3D dataset;
a memory operatively connected to the processor and configured to store the third 3D dataset from which the one or more identified artifacts have been removed; and
a display operatively connected to the memory and configured to display the third 3D dataset from which the one or more identified artifacts have been removed.

17. The system of claim 16, further comprising a C-arm X-ray device comprising a C-arm and an X-ray detector attached to the C-arm,
wherein the X-ray detector is configured to:
generate a plurality of first projections over an angular range of the C-arm; and
generate a plurality of second projections over a plurality of angular ranges of the C-arm, and
wherein the processor is configured to:
reconstruct the first 3D dataset based on the plurality of generated first projections; and
reconstruct the plurality of second 3D datasets based on the plurality of generated second projections.

18. The system of claim 17, wherein the angular range and each angular range of the plurality of angular ranges is 200°.

19. The system of claim 18, wherein the plurality of angular ranges comprises multiple consecutive rotations of the C-arm, and
wherein the multiple consecutive rotations alternate forward and backward, respectively.

20. The system of claim 17, wherein the C-arm is operable to rotate up to 120°/s.

21. A method for artifact removal within computed tomography (CT) image data, the method comprising:
generating, by a processor, a 3D data set representing maximum contrast attenuation over time of a contrast agent in an object;
generating, by the processor, time attenuation curves (TACs) of the contrast agent in the object for voxels corresponding to the 3D data set;
identifying, by the processor, one or more streak artifacts in the 3D data set based on one or more thresholds and the generated TACs; and
removing, by the processor, the one or more identified artifacts from the 3D dataset.
